(19) United States
(12) Patent Application Publication
(10) Pub. No.: US 2006/0139496 A1
(43) Pub. Date: Jun. 29, 2006

(54) Video signal processing apparatus

(75) Inventors: Hiroshi Matsui, Ota-shi (JP); Masato Onaya, Ora-gun (JP)

Correspondence Address: OSHA LIANG L.L.P., 1221 MCKINNEY STREET, SUITE 2800, HOUSTON, TX, 77010, US

(73) Assignee: Sanyo Electric Co., Ltd., Moriguchi-shi (JP)

(21) Appl. No.: 11/315,982

(22) Filed: Dec. 22, 2005

(30) Foreign Application Priority Data
Dec. 27, 2004 (JP) 2004-376825

(51) Int. Cl. H04N 9/77; H04N 9/70; H04N 5/21

(52) U.S. Cl. 348/663; 348/644; 348/631

(57) ABSTRACT

A video signal processing apparatus receives a video signal containing at least a luminance signal and a color difference signal. A trap filter attenuates a frequency band of the color difference signal to separate the luminance signal from the video signal. A bandpass filter attenuates a frequency band of the luminance signal to separate the color difference signal from the video signal. The trap filter is constituted by a switched capacitor filter that outputs the luminance signal with a delay time equivalent to a time difference between a delay time of the processing performed in a succeeding luminance signal processing circuit and a delay time of the processing performed in a color difference signal processing circuit. With this arrangement, the circuit scale of a filter circuit can be reduced and frequency characteristics of the filter can be stabilized.

### CROSS-REFERENCE TO RELATED APPLICATIONS

The entire disclosure of Japanese Patent Application No. 2004-376825 filed Dec. 27, 2004 including specification, claims, drawings, and abstract is incorporated herein by reference.

### BACKGROUND OF THE INVENTION

1. Field of the Invention

The present invention relates to a video signal processing apparatus including a switched capacitor filter used for processing video signals.

2. Description of the Related Art

Video signal processing apparatuses are widely used to convert composite signals, i.e., video signals each including a luminance signal (Y), a color difference signal (C), and a sync signal (Sync), into RGB signals. FIG. 6 shows the arrangement of a conventional video signal processing apparatus. An antenna 10 receives radio waves. A tuner 12 selects video signals of a desired channel. A SAW filter 14 and intermediate-frequency conversion circuit 16 process the selected signals. Then, a Y/C separation circuit 18 separates the signal into two signals: i.e., a combination of luminance signal(Y)+sync signal (Sync) and a color difference signal (C). A signal processing circuit 20 executes processing including contour correction, and a CRT (cathode ray tube) 22 then displays an image.

FIG. 7 shows the circuit arrangement of the Y/C separation circuit 18 and succeeding circuit components.

A video signal produced from the intermediate-frequency conversion circuit 16 is entered into the trap filter 30 and the bandpass filter 32. The trap filter 30 and bandpass filter 32 are generally constructed from CR filters each including a resistor, a capacitor and an operational amplifier. Trap filter 30 has center frequencies of 3.58 MHz and 4.43 MHz and exclusively attenuates corresponding signals whose frequency bands are equal to or near the center frequencies. Trap filter 30 separates, from the video signal, a luminance signal (Y) and a sync signal (Sync) and outputs the separated signals. The bandpass filter 32 has center frequencies of 3.58 MHz and 4.43 MHz and exclusively passes corresponding signals whose frequency bands are equal to or near the center frequencies. The bandpass filter 32 separates, from the video signal, a color difference signal (C) and outputs the separated signal. The luminance signal (Y) is sent from the trap filter 30 to the luminance signal processing circuit 34 in which the signal is subjected to predetermined processing. Then, the luminance signal (Y) is entered into the matrix circuit 38. The color difference signal (C) is sent from the bandpass filter 32 to the chroma signal processing circuit 36 in which the signal is subjected to predetermined processing. Then, the color difference signal (C) is entered into the matrix circuit 38.

The matrix circuit 38 performs matrix transformation processing for each of the luminance signal (Y) and the color difference signal (C) to convert the signals into an RGB color space or other color space. Then, converted signals are output to a post-processing circuit 40. The post-processing circuit 40 performs various corrections for the signals converted into the color space. The signals are sent to the CRT 22.

The matrix circuit 38, before executing transformation processing into the color space, reconstructs (i.e., again composes) the luminance signal (Y) and the color difference signal (C) that have been temporarily separated as described above. Thus, the matrix circuit 38 must synchronously process both the luminance signal (Y) and the color difference signal (C).

However, processing the luminance signal (Y) in the luminance signal processing circuit 34 takes less time compared with processing the color difference signal (C) in the chroma signal processing circuit 36. Thus, compared with the luminance signal (Y), the color difference signal (C) has a delay of several hundred ns when it is produced. Accordingly, the matrix circuit 38 cannot execute synchronous processing for transforming the luminance signal (Y) and the color difference signal (C). This is the reason why deterioration is recognized in an image.

To avoid the above drawbacks, as shown in FIG. 8, an all-pass filter 42 can be disposed between the trap filter 30 and the luminance signal processing circuit 34. According to this arrangement, the all-pass filter 42 can correct a delay time between the color difference signal (C) and the luminance signal (Y). The all-pass filter 42 is generally constructed from a CR filter including a resistor, a capacitor, and an operational amplifier.

The CR filters used as the trap filter 30, bandpass filter 32, and all-pass filter 42 have frequency characteristics varying depending on mutual conductance gm of the operational amplifiers. The frequency characteristics of a CR filter thus change when gm of an operational amplifier is changed. Furthermore, gm of the operational amplifier cannot be constant over a wide range, when the change of input voltage is taken into consideration. Thus, any change occurring in the input voltage possibly changes the frequency characteristics of a CR filter. In other words, with respect to a video signal or a luminance signal (Y), performing filtering while maintaining constant frequency characteristics is only feasible in a limited narrow range of the input voltage.

In particular, according to the circuit including a serial connection of the trap filter 30 and the all-pass filter 42, a dynamic range for processing an input signal while maintaining desired frequency characteristics is extremely narrow and the circuit scale is large.

Furthermore, frequency characteristics of a CR filter vary in response to variation in a resistor or a capacitor of the CR filter. Thus, optimizing individual filtering characteristics is difficult.

### SUMMARY OF THE INVENTION

A video signal processing apparatus according to the present invention receives a video signal containing at least a luminance signal and a color difference signal. The video signal processing apparatus includes a trap filter, a bandpass filter, a luminance signal processing circuit, and a color difference signal processing circuit. The trap filter attenuates a frequency band of the color difference signal to separate the luminance signal from the video signal. The bandpass filter attenuates a frequency band of the luminance signal to separate the color difference signal from the video signal. The luminance signal processing circuit performs predetermined processing for the luminance signal produced from the trap filter. Also, the color difference signal processing circuit performs predetermined processing for the color difference signal produced from the bandpass filter. The trap filter is constituted by a switched capacitor filter that outputs the luminance signal with a delay time equivalent to a time difference between a delay time of processing performed in the luminance signal processing circuit and a delay time of processing performed in the color difference signal processing circuit.

### BRIEF DESCRIPTION OF THE DRAWINGS

The accompanying drawings, which are incorporated in and constitute a part of the specification, illustrate an embodiment of the invention and, together with the description, serve to explain the principles of the invention, in which:

FIG. 1 is a block diagram showing the arrangement of a video signal processing apparatus in accordance with one embodiment of the present invention;

FIG. 2 is a circuit diagram showing the arrangement of a comb filter in accordance with one embodiment of the present invention;

FIG. 3 is a waveform diagram showing functions of the comb filter in accordance with one embodiment of the present invention;

FIG. 4 is a circuit diagram showing a tap filter contained in a Y/C separation circuit in accordance with one embodiment of the present invention;

FIG. 5 is a timing chart showing functions of the tap filter provided in a Y/C separation circuit in accordance with one embodiment of the present invention;

FIG. 6 is a block diagram showing a conventional video signal processing apparatus;

FIG. 7 is a block diagram showing a Y/C separation circuit and succeeding circuit components in accordance with the conventional video signal processing apparatus; and

FIG. 8 is a block diagram showing a Y/C separation circuit including an all-pass filter in accordance with the conventional video signal processing apparatus.

### DESCRIPTION OF PREFERRED EMBODIMENT

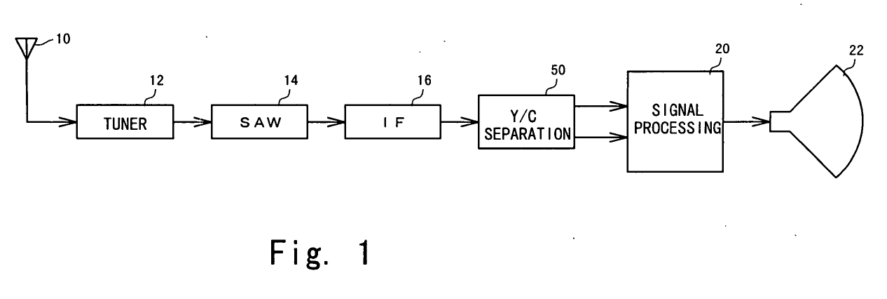

A video signal processing circuit according to one embodiment of the present invention, as shown in FIG. 1, includes an antenna 10, SAW filter 14, intermediate-frequency conversion circuit 16, Y/C separation circuit 50, signal processing circuit 20, and CRT 22.

According to the video signal processing circuit of the present embodiment, like the above-described conventional processing circuit, the antenna 10 receives radio waves. The tuner 12 selects video signals of a desired channel. The SAW filter 14 removes signals of unnecessary frequency bands. The intermediate-frequency conversion circuit 16 converts the signal into an intermediate-frequency band signal whose frequency band is lower than that of the received signal. The Y/C separation circuit 50 separates the intermediate-frequency band signal into two signals; i.e., a combination of luminance signal (Y)+sync signal (Sync) and a color difference signal (C). The signal processing circuit 20 executes processing including contour correction. CRT 22 displays an image.

The Y/C separation circuit 50 of the embodiment has the following characteristics.

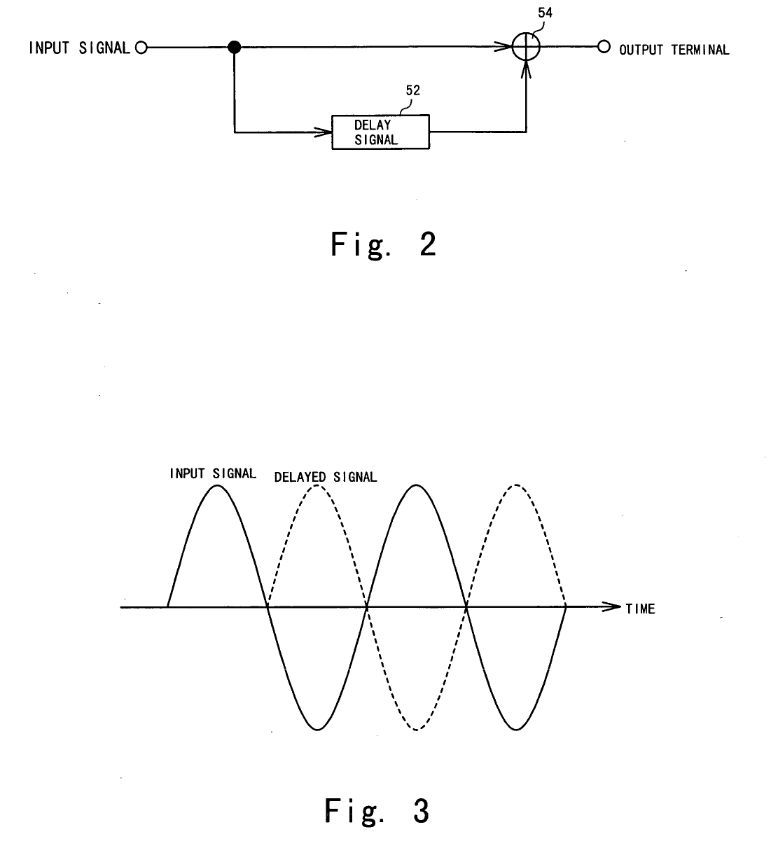

A trap filter provided in the Y/C separation circuit 50 is a comb filter constructed from a switched capacitor filter (i.e., an SC filter). The comb filter, as shown in FIG. 2, includes a delay circuit 52 and an adder 54. In the comb filter, delay circuit 52 receives an input signal (i.e., a frequency signal to be attenuated) and delays the signal by a half period. The adder 54 adds a delayed signal with the original signal to output a composite signal. Thus, as shown in FIG. 3, signals in a frequency band including or in the vicinity of a center frequency cancel each other out.

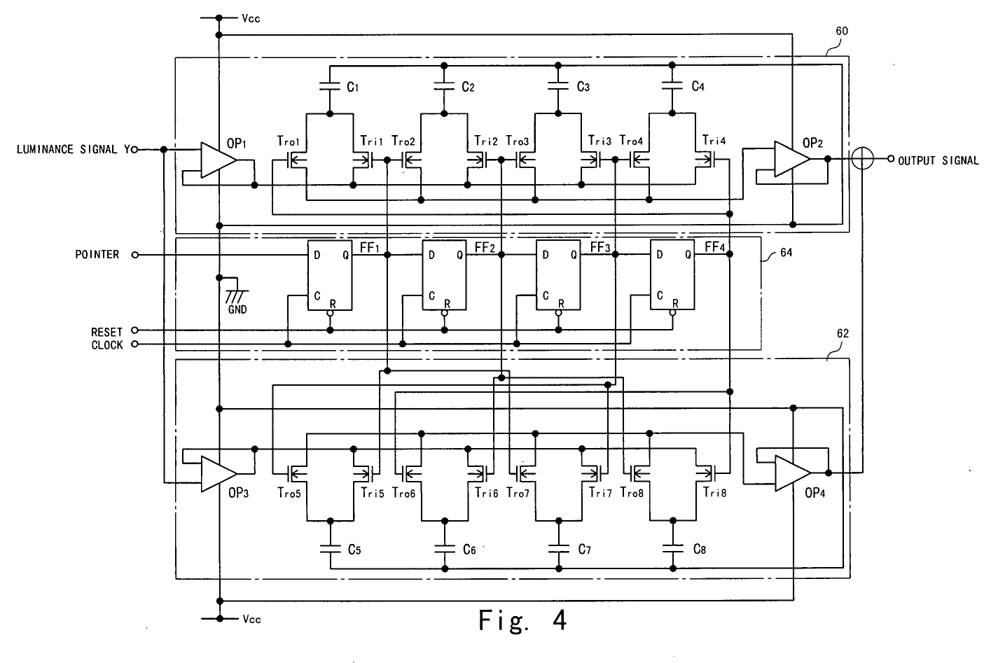

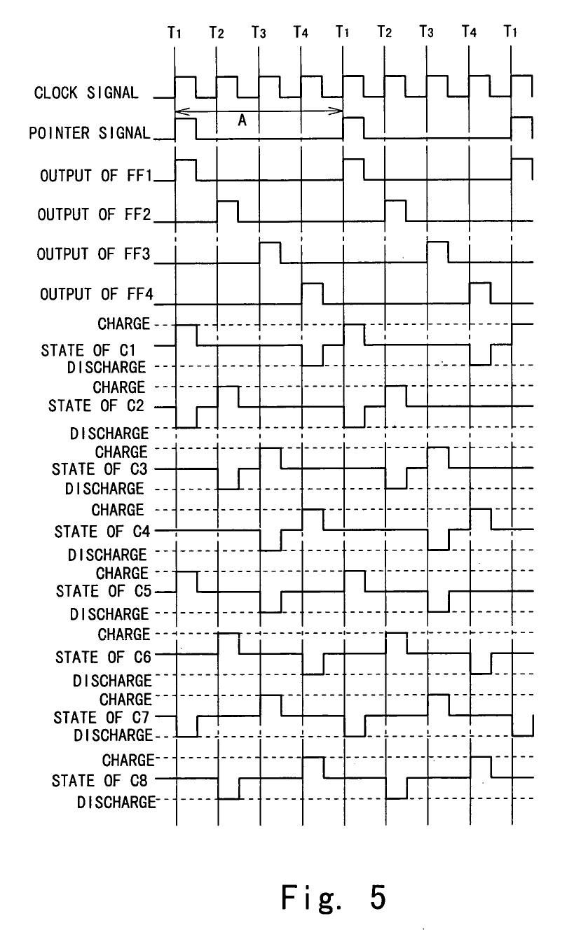

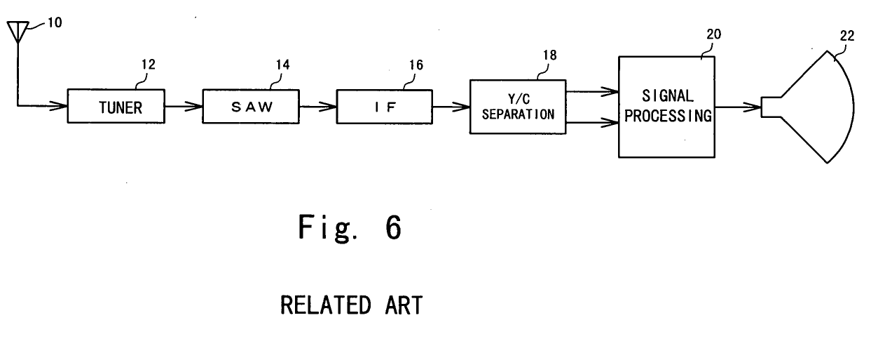

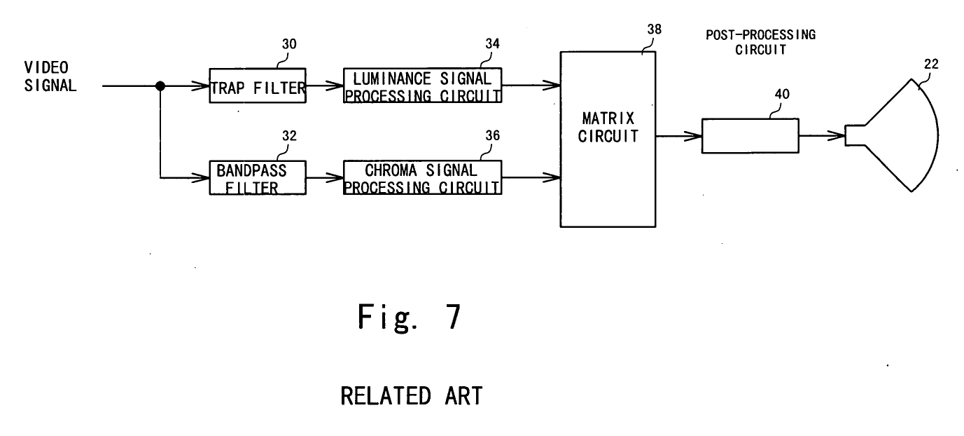

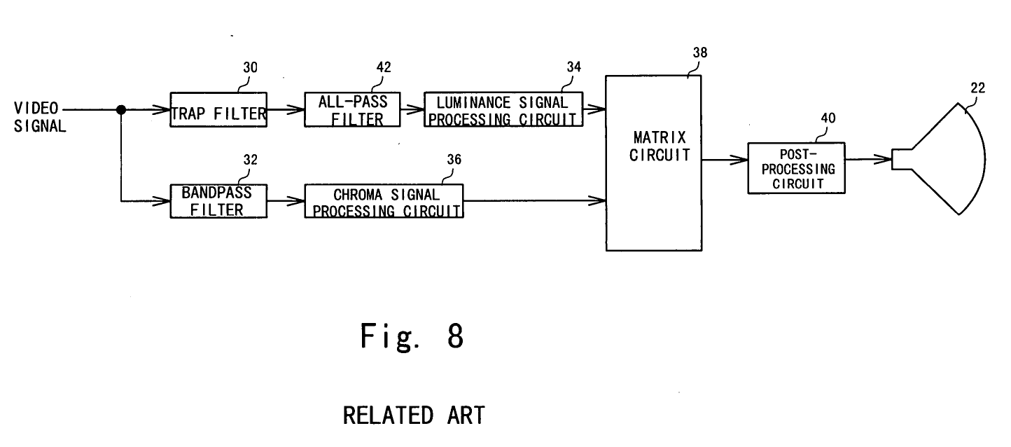

FIG. 4 shows the detailed arrangement of the SC filter (i.e., the trap filter) provided in the Y/C separation circuit 50. The SC filter includes two delay circuits 60 and 62 and a shift register 64. The delay circuit 60 includes operational amplifiers OP1 and OP2, capacitors C1 to C4, and transistors Tri1-Tri4 and Tro1-Tro4. Delay circuit 62 includes operational amplifiers OP3 and OP4, capacitors C5 to C8, and transistors Tri5-Tri8 and Tro5-Tro8. Shift register 64 includes D-flip flop circuits FF1 to FF4 which are serially connected with each other.

A clock signal and a reset signal enter from a clock terminal C and a reset terminal R of respective flip flop circuits FF1 to FF4. A pointer signal enters from an input terminal D of a first-stage flip flop circuit FF1. An output terminal Q of the first-stage flip flop circuit FF1 is connected to an input terminal D of a second-stage flip flop circuit FF2. Similarly, output terminals Q of respective flip flop circuits FF2 and FF3 are connected to input terminals D of succeeding flip flop circuits FF3 and FF4. Furthermore, transistors Tri1-Tri8 and Tro1-Tro8 of the delay circuits 60 and 62 have gates connected to one of the output terminals Q of respective flip flop circuits FF1 to FF4.

The delay circuit 60 receives an input signal via the operational amplifier OP1 functioning as a buffer. An input signal of the Y/C separation circuit 50 is a video signal including a luminance signal (Y) and a color difference signal (C) combined with each other. An output terminal of the operational amplifier OP1 is grounded via a first serial circuit including a drain-source of transistor Tri1 and a capacitor C1, or a second serial circuit including a drain-source of transistor Tri2 and a capacitor C2, or a third serial circuit including a drain-source of transistor Tri3 and a capacitor C3, or a fourth serial circuit including a drain-source of transistor Tri4 and a capacitor C4. With this arrangement, when any one of the transistors Tri1 to Tri4 is turned on, a corresponding capacitor (i.e., any one of the capacitors C1 to C4) associated with the transistor in an ON state is charged with the voltage of the input signal.

A connecting point of transistor Tri1 and capacitor C1 is connected to an input terminal of the operational amplifier OP2 via a source-drain of transistor Tro1. A connecting point of transistor Tri2 and capacitor C2 is connected to the input terminal of the operational amplifier OP2 via a source-drain of transistor Tro2. A connecting point of transistor Tri3 and capacitor C3 is connected to the input terminal of the operational amplifier OP2 via a source-drain of transistor Tro3. Also, a connecting point of transistor Tri4 and capacitor C4 is connected to the input terminal of the operational amplifier OP2 via a source-drain of transistor Tro4. The operational amplifier OP2 functions as a buffer. With this arrangement, when any one of transistors Tr01 to Tr04 is turned on, the charged voltage of a corresponding capacitor (i.e., any one of the capacitors C1 to C4) associated with the transistor in an ON state is output to an adder circuit via the operational amplifier OP2.

Output terminal Q of the first-stage flip flop circuit FF1 is connected to a common gate of transistors Tri1 and Tro2. Output terminal Q of the second-state flip flop circuit FF2 is connected to a common gate of transistors Tri2 and Tro3. Output terminal Q of the third-stage flip flop circuit FF3 is connected to a common gate of transistors Tri3 and Tro4, and output terminal Q of the fourth-stage flip flop circuit FF4 is connected to a common gate of transistors Tri4 and Tro1. In the shift register 64, a pointer shifts in synchronism with cycles of a clock signal so that the output terminals Q of respective flip flop circuits FF1 to FF4 are sequentially turned into Hi-level. When transistors Tri1 and Tro2 are both in an ON state, capacitor C1 is charged with the voltage of input signal while the charged voltage of the capacitor C2 is output to the operational amplifier OP2. Subsequently, when transistors Tri2 and Tro3 become ON state, capacitor C2 is charged with the voltage of input signal while the charged voltage of the capacitor C3 is output to the operational amplifier OP2. In this manner, charging and discharging operations of respective capacitors C1 to C4 are sequentially repeated.

The delay circuit 62 is substantially similar to the delay circuit 60 in circuit arrangement. The delay circuit 62 receives an input signal via the operational amplifier OP3 functioning as a buffer. An output terminal of the operational amplifier OP3 is grounded via a fifth serial circuit including a drain-source of transistor Tri5 and a capacitor C5, or a sixth serial circuit including a drain-source of transistor Tri6 and a capacitor C6, or a seventh serial circuit including a drain-source of transistor Tri7 and a capacitor C7, or an eighth serial circuit including a drain-source of transistor Tri8 and a capacitor C8. With this arrangement, when any one of the transistors Tri5 to Tri8 is turned on, a corresponding capacitor (i.e., any one of the capacitors C5 to C8) associated with the transistor of ON state is charged with the voltage of input signal.

A connecting point of transistor Tri5 and capacitor C5 is connected to an input terminal of the operational amplifier OP4 via a source-drain of transistor Tro5. A connecting point of transistor Tri6 and capacitor C6 is connected to the input terminal of the operational amplifier OP4 via a source-drain of transistor Tro6. A connecting point of transistor Tri7 and capacitor C7 is connected to the input terminal of the operational amplifier OP4 via a source-drain of transistor Tro7. Also, a connecting point of transistor Tri8 and capacitor C8 is connected to the input terminal of the operational amplifier OP4 via a source-drain of transistor Tro8. With this arrangement, when any one of the transistors Tr05 to Tr08 is turned on, the charged voltage of a corresponding capacitor (i.e., any one of the capacitors C5 to C8) associated with the transistor in an ON state is output to the adder circuit via the operational amplifier OP4.

Output terminal Q of the first-stage flip flop circuit FF1 is connected to a common gate of transistors Tri5 and Tro7. Output terminal Q of the second-stage flip flop circuit FF2 is connected to a common gate of transistors Tri6 and Tro8. Output terminal Q of the third-stage flip flop circuit FF3 is connected to a common gate of transistors Tri7 and Tro5. Output terminal Q of the fourth-stage flip flop circuit FF4 is connected to a common gate of transistors Tri8 and Tro6. In the shift register 64, a pointer shifts in synchronism with cycles of a clock signal so that the output terminals Q of respective flip flop circuits FF1 to FF4 are sequentially turned into Hi-level. When transistors Tri5 and Tro7 are both in an ON state, capacitor C5 is charged with the voltage of input signal while the charged voltage of the capacitor C7 is output to the operational amplifier OP4. Subsequently, when transistors Tri6 and Tro8 become ON state, capacitor C6 is charged with the voltage of input signal while the charged voltage of the capacitor C8 is output to the operational amplifier OP4. In this manner, charging and discharging operations for respective capacitors C5 to C8 are sequentially repeated.

An output of the operational amplifier OP2 in the delay circuit 60 and an output of the operational amplifier OP4 in the delay circuit 62 are composed and sent as an output signal to the signal processing circuit 20.

Operations of the video signal processing circuit according to the present embodiment will be described with reference to FIG. 5 in the following. A clock signal includes pulses rising up periodically at times T1, T2, T3, - - - . A pointer signal includes pulses rising up periodically at intervals of a period “A” that is equal to a multiplication of a period of the clock signal by a total number (i.e., 4) of the flip flop circuits in the shift register 64.

In response to inputs of the clock signal and the pointer signal, flip flop circuits FF1 to FF4 of the shift register 64 sequentially output pulses from the output terminals Q. The output pulses are transmitted to the gates of transistors Tri1-Tri8 and Tro1-Tro8 to perform charging and discharging operations for respective capacitors C1 to C8.

As shown in FIG. 5, output Q of the flip flop circuit FF1 rises up at time T1. In response to the rise-up, the capacitor C1 is charged in accordance with the voltage of the input signal while the charged voltage of the capacitor C2 is discharged to the operational amplifier OP2. Simultaneously, the capacitor C5 is charged in accordance with the voltage of input signal while the charged voltage of the capacitor C7 is discharged to the operational amplifier OP4. Output Q of the flip flop circuit FF2 rises up at time T2. In response to the rise-up, the capacitor C2 is recharged in accordance with the voltage of input signal while the charged voltage of the capacitor C3 is discharged to the operational amplifier OP2. Simultaneously, the capacitor C6 is charged in accordance with the voltage of input signal while the charged voltage of the capacitor C8 is discharged to the operational amplifier OP4. Output Q of the flip flop circuit FF3 rises up at time T3. In response to the rise-up, the capacitor C3 is recharged in accordance with the voltage of input signal while the charged voltage of the capacitor C4 is discharged to the operational amplifier OP2. Simultaneously, the capacitor C7 is charged in accordance with the voltage of input signal while the charged voltage of the capacitor C5 is discharged to the operational amplifier OP4. Also, output Q of the flip flop circuit FF4 rises up at time T4. In response to the rise-up, the capacitor C4 is recharged in accordance with the voltage of input signal while the charged voltage of the capacitor C1 is discharged to the operational amplifier OP2. Simultaneously, the capacitor C8 is charged in accordance with the voltage of input signal while the charged voltage of the capacitor C6 is discharged to the operational amplifier OP4.

In this manner, charging different capacitors at the same time in accordance with the voltage of an input signal while outputting the charged voltage of respective capacitors after mutually different delay times have passed makes it possible to arrange a comb filter capable of canceling the signals whose frequency bands are equal to or near the center frequencies.

More specifically, the delay circuit 60 outputs the voltage value of an input signal having been entered 4 clocks before. On the other hand, the delay circuit 62 outputs the voltage value of an input signal having been entered 2 clocks before. Accordingly, when a time period corresponding to 2 clocks of the clock signal agrees with a half period of the signal having a center frequency to be attenuated, signals whose frequency bands are equal to or near the center frequencies can be attenuated. The center frequency can be changed by adjusting a period of the clock signal or a stage difference of flip flop circuits.

Furthermore, an overall delay time common to the delay circuits 60 and 62 is equivalent to the time of 2 clocks. The overall delay time can be changed by increasing the number of circuit stages contained in respective delay circuits 60 and 62 by the same number. Thus, the stage number of a trap filter with respect to the luminance signal (Y) should be adjusted so as to cancel a difference in delay time between the processing of the color difference signal (C) in the chroma signal processing circuit 36 and the processing of the luminance signal (Y) in the luminance signal processing circuit 34. With such an adjustment, the overall delay time can be equalized with a delay time difference between the processing of the color difference signal (C) in the chroma signal processing circuit 36 and the processing of the luminance signal (Y) in the luminance signal processing circuit 34.

Therefore, without providing an all-pass filter (constructed from a CR filter) in addition to a trap filter, the time difference between the luminance signal (Y) and the color difference signal (C) can be eliminated when the signals are entered into the matrix circuit 38. Accordingly, deterioration in image quality can be reduced.

Although the present embodiment discloses the delay circuits 60 and 62 respectively using four stages of capacitors C1 to C4 or capacitors C5 to C8, an overall delay time of the tap filter and a delay difference between the delay circuit 60 and the delay circuit 62 can be appropriately changed by adjusting the stage number of shift registers and capacitors or by adjusting the clock pulse period.

While the present invention has been described with reference to an exemplary embodiment, it is to be understood that the invention is not limited to the disclosed exemplary embodiment. The scope of the following claims is to be accorded the broadest interpretation so as to encompass all modifications, equivalent structures and functions.

What is claimed is:

1. A video signal processing apparatus receiving a video signal containing at least a luminance signal and a color difference signal, comprising:
a trap filter for attenuating a frequency band of the color difference signal to separate the luminance signal from the video signal;
a bandpass filter for attenuating a frequency band of the luminance signal to separate the color difference signal from the video signal;
a luminance signal processing circuit for applying predetermined processing to the luminance signal produced from the trap filter; and
a color difference signal processing circuit for applying predetermined processing to the color difference signal produced from the bandpass filter,
wherein the trap filter is arranged by a switched capacitor filter that outputs the luminance signal with a delay time equivalent to a time difference between a delay time of processing performed in the luminance signal processing circuit and a delay time of processing performed in the color difference signal processing circuit.

2. The video signal processing apparatus according to claim 1, wherein
the switched capacitor filter, constituting the trap filter, comprises first and second delay circuits and a shift register,
the first and second delay circuits include a plurality of capacitors each associated with a first switching element and a second switching element,
the first switching element controls connection of the capacitor to an input terminal of the video signal in response to a pointer signal for performing charging of the capacitor to a voltage corresponding to the luminance signal,
the second switching element controls connection of the capacitor to an output terminal in response to a pointer signal for outputting an output voltage corresponding to the voltage charged in the capacitor, and
the shift register successively outputs the pointer signal to respective switching elements in the first and second delay circuits for controlling charging or discharging of the capacitors.

3. The video signal processing apparatus according to claim 1, wherein a time difference between charging and discharging operations of each capacitor provided in the first delay circuit is differentiated from a time difference between charging and discharging operations of each capacitor provided in the second delay circuit.

4. The video signal processing apparatus according to claim 2, wherein a time difference between charging and discharging operations of each capacitor provided in the first delay circuit is differentiated from a time difference between charging and discharging operations of each capacitor provided in the second delay circuit.
